(19) United States
(12) Patent Application Publication
(10) Pub. No.: US 2017/0072650 A1
(43) Pub. Date: Mar. 16, 2017

(54) OPTICAL LENS AND INJECTION MOLD THEREOF

(71) Applicant: EVERREADY PRECISION IND. CORP., KAOHSIUNG CITY (TW)

(72) Inventors: JYH-LONG CHERN, TAIPEI CITY (TW); CHIH-MING YEN, TAIPEI CITY (TW); CHIN-CHENG CHEN, KAOHSIUNG CITY (TW)

(21) Appl. No.: 14/928,211

(22) Filed: Oct. 30, 2015

(30) Foreign Application Priority Data
Sep. 11, 2015 (CN) 201510578257.X
Sep. 11, 2015 (TW) 104130132

(51) Int. Cl. B29D 11/00; G02B 13/00; G02B 1/11; B29C 45/26; B29C 45/20

(52) U.S. Cl. CPC B29D 11/00538; B29C 45/2616; B29C 45/20; B29D 11/00519; G02B 1/11; G02B 13/0015; B29K 2995/0026; B29K 2101/12

(57) ABSTRACT

An injection mold and an optical lens produced from the injection mold are provided. The injection mold includes a disk-type mold base and a nozzle. A mold cavity chamber is defined by the disk-type mold base. The mold cavity chamber includes an optically effective central runner and an optically ineffective annular runner. Moreover, plural spoiler structures are formed in the optically ineffective annular runner. While a melt is injected from the nozzle to the mold cavity chamber, the plural spoiler structures provide the functions of disturbing the melt flow and decreasing the velocity of the melt in the optically ineffective annular runner. Consequently, before the optically ineffective annular runner is completely filled with the melt, the optically effective central runner is completely filled with the melt. Since no defect is formed in an optically effective zone, the yield of the optical lens is enhanced.

### FIELD OF THE INVENTION

The present invention relates to an injection mold and an optical lens produced from the injection mold, and more particularly to a high-yield injection mold and a high-quality optical lens produced from the injection mold.

### BACKGROUND OF THE INVENTION

With the advance of science and technology, the processes of fabricating many miniature objects are developed which may be beyond one's imagination. As one of the examples sensing modules in mobile devices, e.g., mobile phone, can be a big category of this kind of miniature apparatus. On the other hand, not less common, the trends of developing optical lenses are toward smaller diameter and reduced thickness even in wafer level. Indeed, the optical lenses are developed toward miniaturization to meet the demands from the customers. Moreover, since the functions of electronic devices are progressively diversified, optical lenses are integrated into mobile electronic devices in the electronic industries and consumer applications where new emergent utilization can be found. For instance, an optical lens and a laser source can be cooperatively used to provide the function of generating a structured light for human interactive and distance ranging including the application of auto-focusing. Because of miniaturization, the request on lens quality has been pushed to a higher standard. The consideration of good yield and high precision in fabrication and mass production is essential. In many circumstances, the production of optical lenses is based on plastic injection. Hence, a good injection mold, which can balance all kinds of force and jets inside the mold when injection, is also critical.

FIG. 1 is a schematic perspective view illustrating a front side of a conventional injection mold. As shown in FIG. 1, the conventional injection mold 1 has a top curved structure 10 that is cambered upwardly. FIG. 2 is a schematic perspective view illustrating a rear side of the conventional injection mold. As shown in FIG. 2, the conventional injection mold 1 also has a bottom curved structure 11 that is cambered upwardly. During the process of producing the optical lens, a melt is introduced into a chamber of the injection mold through a gate 12. The chamber is defined by the top curved structure 10 and the bottom curved structure 11 collaboratively. After the melt is cooled, a newly-formed optical lens with a curve can be removed from the injection mold.

FIG. 3 is a schematic cross-sectional view illustrating the conventional injection mold of FIG. 1 and taken along the line A-A. As shown in FIG. 3, the bottom curved structure 11 is cambered upwardly toward the chamber 15. Consequently, a greater portion of the melt is guided to quickly flow around the outer surface of the bottom curved structure 11. That is, the greater portion of the melt flows in the direction indicated by the arrow 17. In addition, another portion of the melt flows slowly along the bottom curved structure 11 and ascends over the bottom curved structure 11 (i.e., in the direction indicated by the arrow 18).

In the conventional injection mold 1, the runner at the annular region of the chamber 15 is higher than the runner at the central region of the chamber 15. Consequently, the melt can flow along the annular region of the chamber 15 with less resistance. That is, the flow velocity of the melt 8 at the annular region of the chamber 15 is faster than the flow velocity of the melt 8 at the central region of the chamber 15. The flowing condition of the melt within the chamber during the process of forming the optical lens with the conventional injection mold is shown in FIG. 4. The use of the conventional injection mold 1 still has some drawbacks. For example, before the central region (i.e., the optically effective zone of the optical lens) is completely filled with the melt 8, the annular region (i.e., the optically ineffective zone of the optical lens) is completely filled with the melt 8. After the final optical lens is formed, a pore or melt line 19 is possibly formed in the central region (i.e., the optically effective zone of the optical lens). Under this circumstance, the optical performance of the optical lens is largely deteriorated.

For solving the above drawbacks, researchers in the technical field of optical lens are devoted to the study of producing useful optical lenses. Therefore, there is a need of providing an injection mold for producing an optical lens with good optical performance.

### SUMMARY OF THE INVENTION

An object of the present invention provides high-quality optical lens and an injection mold for producing the optical lens. The injection mold comprises plural spoiler structures. The plural spoiler structures are formed in an optically ineffective annular runner of the injection mold in order to decrease the flow velocity of the melt and change the flow direction of the melt in the optically ineffective annular runner. Consequently, the pore, melt line or the improper bi-refraction or multi-refraction block will not be formed in an optically effective zone of the optical lens.

In accordance with an aspect of the present invention, there is provided an injection mold for receiving a melt and producing an optical lens. The injection mold includes a disk-type mold base and at least one nozzle. A mold cavity chamber and a gate are defined by the disk-type mold base. The gate is in communication with the mold cavity chamber. The mold cavity chamber includes an optically effective central runner and an optically ineffective annular runner. The optically effective central runner is arranged between a top curved surface and a bottom curved surface within the disk-type mold base, so that an outer contour of the optical lens matches the top curved surface and the bottom curved surface. The optically ineffective annular runner is arranged around the optically effective central runner. The optically ineffective annular runner is in communication with the optically effective central runner and the gate. The disk-type mold base includes plural spoiler structures in the optically ineffective annular runner. The at least one nozzle is connected with the disk-type mold base. The melt is injected from the at least one nozzle into the mold cavity chamber through the gate. The plural spoiler structures disturb flow of the melt, so that the optically effective central runner is completely filled with the melt before the optically ineffective annular runner is completely filled with the melt.

In an embodiment, the disk-type mold base is a circular disk-type mold base, and the plural spoiler structures include plural spoiler bulges and/or plural spoiler recesses.

In an embodiment, the disk-type mold base includes an upper-half mold base and a lower-half mold base. The upper-half mold base and the lower-half mold base are combined together to collaboratively define the mold cavity chamber.

In an embodiment, the plural spoiler structures are included in the optically ineffective annular runner in a circular permutation, and the plural spoiler structures are arranged around the optically effective central runner.

In an embodiment, at least one of the plural spoiler structures is included in the optically ineffective annular runner, and located near the gate.

In an embodiment, two of the plural spoiler structures are included in the optically ineffective annular runner, and symmetrically located at bilateral sides with respect to an injection direction of the gate.

In an embodiment, a curvature center of the top curved surface and a curvature center of the bottom curved surface are located at the same side with respect to the disk-type mold base.

In an embodiment, the top curved surface and the bottom curved surface are cambered upwardly, and the plural spoiler structures are protruded upwardly toward the top curved surface.

In an embodiment, the at least one nozzle includes plural nozzles, and the plural nozzles are in communication with the disk-type mold base.

In accordance with another aspect of the present invention, there is provided an optical lens. The optical lens is produced from an injection mold by an injection molding process. The optical lens includes a lens body, an optically effective zone, an optically ineffective zone, and plural mating structures corresponding to plural spoiler structures of the injection mold. The optically effective zone is located at a central region of the lens body, wherein plural light beams are allowed to pass through the optically effective zone. The optically ineffective zone is located at a peripheral region of the lens body, and arranged around the optically effective zone. The plural mating structures are included in the optically ineffective zone and arranged around the optically effective zone.

In an embodiment, the lens body includes a gate land, wherein at least one of the plural mating structures is located near the gate land.

In an embodiment, the lens body includes a gate land. Moreover, two of the plural mating structures are located near the gate land, and symmetrically located at bilateral sides with respect to a normal line of the gate land.

In an embodiment, the lens body includes a top curved surface and a bottom curved surface. The top curved surface and the bottom curved surface are cambered upwardly in the same direction.

In an embodiment, inner surfaces of the mating structures, the top curved surface and the bottom curved surface are cambered upwardly in the same direction.

In an embodiment, a sprayed coating is formed on the optical lens corresponding to the optically ineffective zone, wherein the sprayed coating has a wave-breaking function so as to reduce reflection or diffusion of light.

In an embodiment, the plural mating structures include plural mating recesses and/or plural mating bulges.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a front side of a conventional injection mold;

FIG. 2 is a schematic perspective view illustrating a rear side of the conventional injection mold;

FIG. 3 is a schematic cross-sectional view illustrating the conventional injection mold of FIG. 1 and taken along the line A-A;

FIG. 4 schematically illustrates the flowing condition of the melt within the chamber during the process of forming the optical lens with the conventional injection mold;

FIG. 5 is a schematic perspective view illustrating a front side of an injection mold for producing an optical lens according to an embodiment of the present invention;

FIG. 6 is a schematic perspective view illustrating a rear side of the injection mold according to the embodiment of the present invention;

FIG. 7 is a schematic cross-sectional view illustrating the injection mold of FIG. 5 and taken along the line B-B;

FIG. 8 is a schematic top view illustrating an optical lens formed from the injection mold of the present invention;

FIG. 9 schematically illustrates the relationship between the top view and the cross-sectional view of the optical lens of the present invention; and

FIG. 10 schematically illustrates the flowing condition of the melt within the mold cavity chamber during the process of forming the optical lens with the injection mold of the present invention.

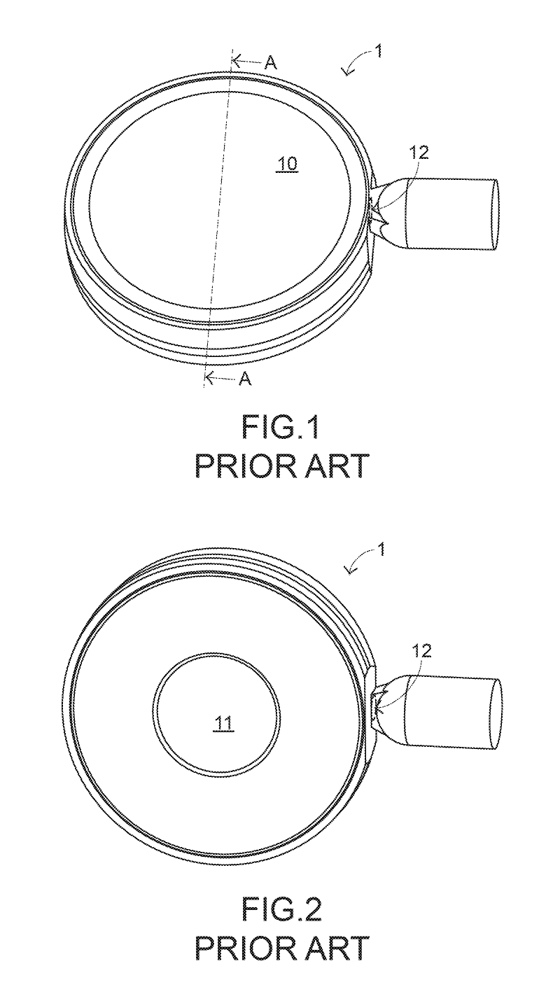

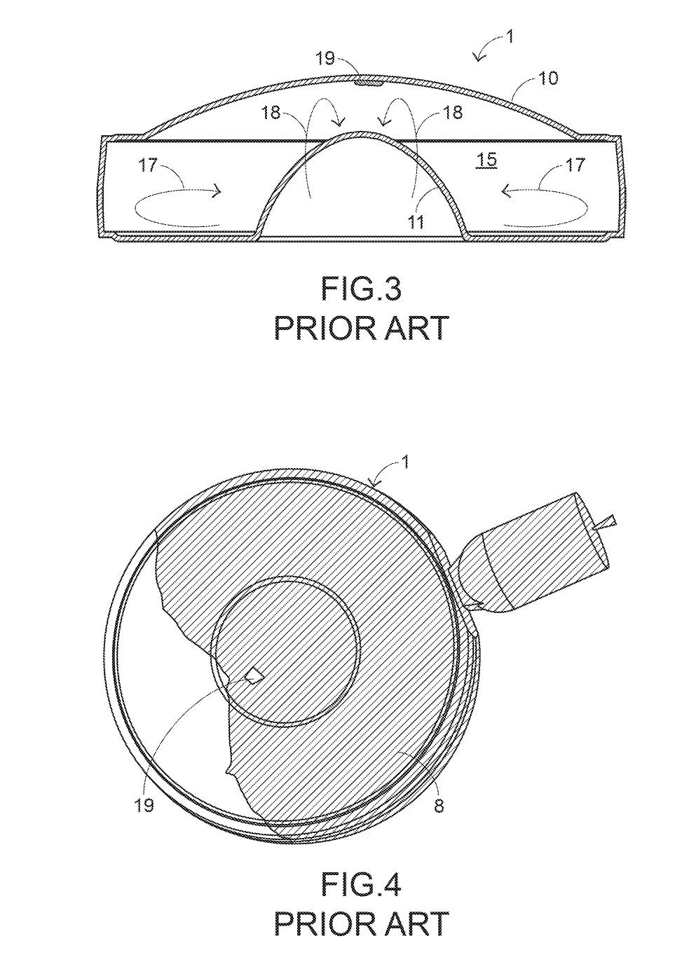

### DETAILED DESCRIPTION OF THE PREFERRED EMBODIMENT

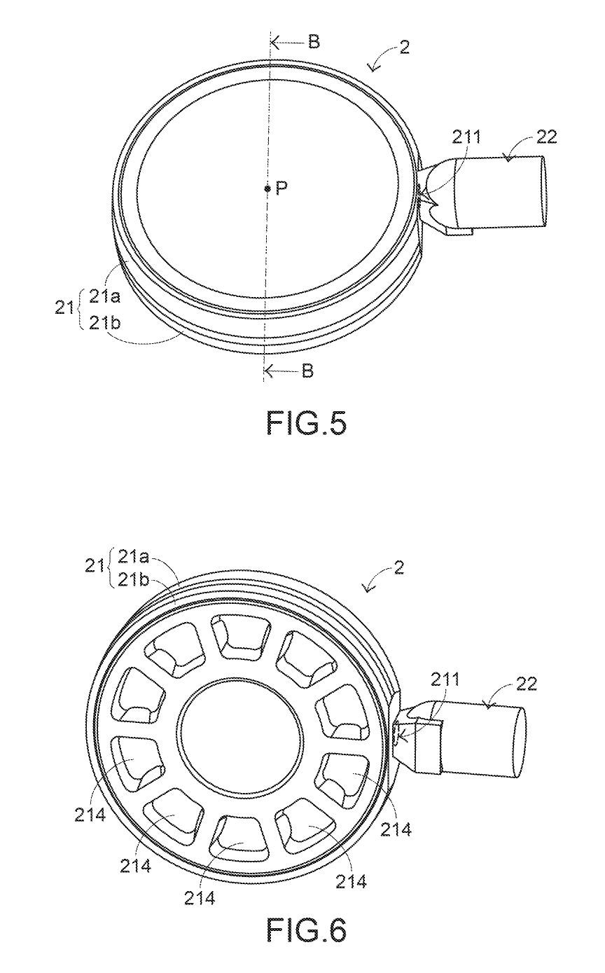

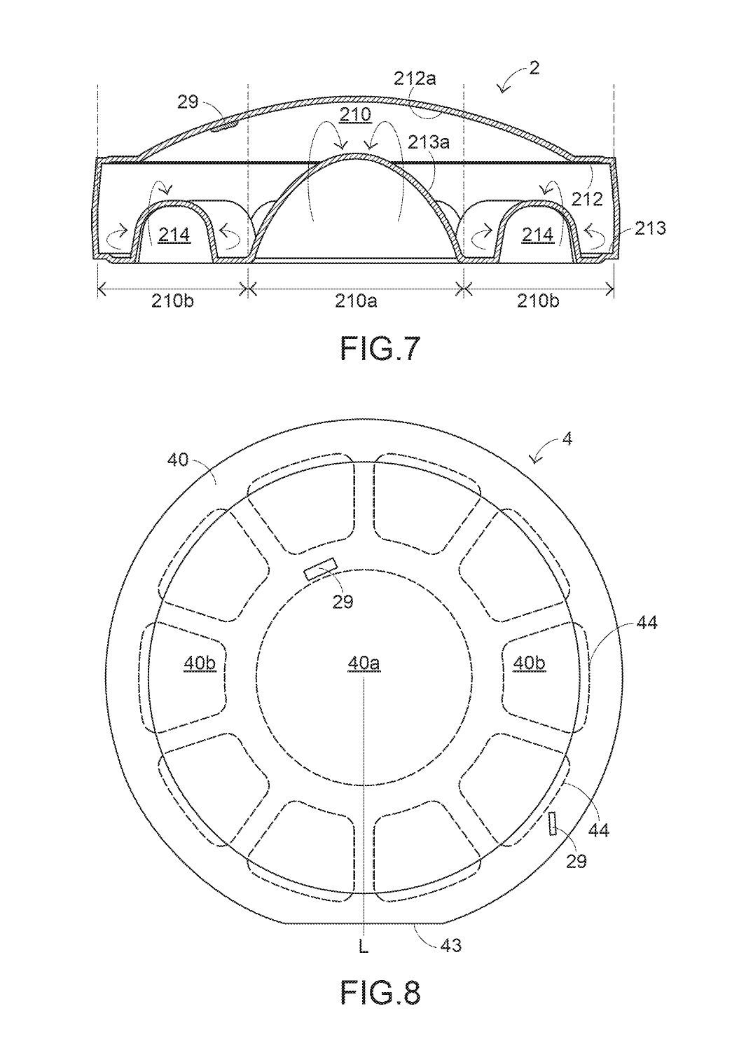

FIG. 5 is a schematic perspective view illustrating a front side of an injection mold for producing an optical lens according to an embodiment of the present invention. FIG. 6 is a schematic perspective view illustrating a rear side of the injection mold according to the embodiment of the present invention. FIG. 7 is a schematic cross-sectional view illustrating the injection mold of FIG. 5 and taken along the line B-B. Please refer to FIGS. 5, 6 and 7. The injection mold 2 comprises a disk-type mold base 21 and a nozzle 22. The nozzle 22 is connected with the disk-type mold base 21. Moreover, the inner space of the nozzle 22 is in communication with the inner space of the disk-type mold base 21. A top surface of the disk-type mold base 21 is cambered upwardly. A center point of the top surface of the disk-type mold base 21 is a curved surface climax P. Consequently, an optical lens with a similar curved surface can be produced according to the disk-type mold base 21.

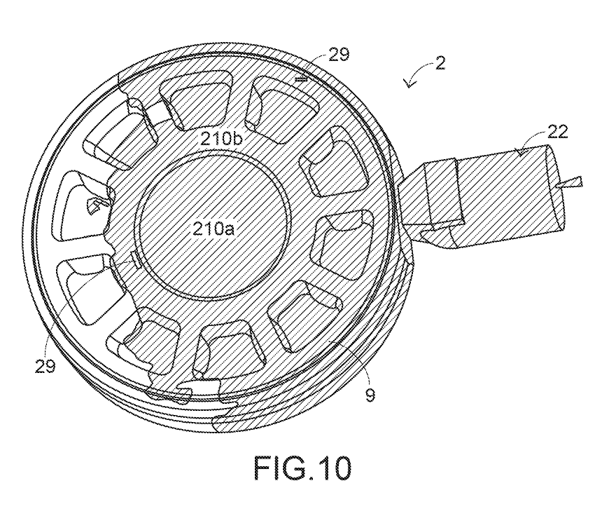

A mold cavity chamber 210 (see FIG. 7) and a gate 210 (see FIGS. 5 and 6) are defined within the disk-type mold base 21. The gate 211 is in communication with the mold cavity chamber 210. During the process of producing the optical lens, a melt 9 is ejected out from the nozzle 22 and injected into the mold cavity chamber 210 through the gate 211. In particular, during the process of producing the optical lens, the mold cavity chamber 210 is gradually filled with the melt 9. As shown in FIG. 10, the region indicated by oblique lines represents the flow condition of the melt 9. After the melt 9 is solidified, an optical lens is removed in a cleavage manner or a trimming manner. Then, the optical lens can be applied to the assembly of a camera lens module. Moreover, an example of the melt 9 includes but is not limited to a molten plastic material, a molten glass material or any other appropriate thermoplastic transparent material.

Please refer to FIG. 7 again. The disk-type mold base 21 of the injection mold 2 has a top inner surface 212 and a bottom inner surface 213. The mold cavity chamber 210 for forming the outer contour of the optical lens is defined by the top inner surface 212 and the bottom inner surface 213 of the disk-type mold base 21. The mold cavity chamber 210 is a runner space for allowing the melt 9 to flow through. In this embodiment, the mold cavity chamber 210 comprises an optically effective central runner 210a and an optically ineffective annular runner 210b. The optically effective central runner 210a is arranged between a top curved surface 212a of the top inner surface 212 and a bottom curved surface 213a of the bottom inner surface 213.

Moreover, both of the top curved surface 212a and the bottom curved surface 213a are cambered upwardly. That is, the curvature center of the top curved surface 212a and the curvature center of the bottom curved surface 213a are located at the same side with respect to the disk-type mold base 21. Moreover, after the injected melt 9 is solidified, the shape of the optical lens matches the top inner surface 212 and the bottom inner surface 213 of the disk-type mold base 21. Consequently, the outer contour of the solidified melt 9 is determined according to the contours of the top inner surface 212 and the bottom inner surface 213 of the disk-type mold base 21. For example, the solidified melt 9 may be designed to have the outer contour of a convex-concave lens, a concave-convex lens, a biconvex lens or a biconcave lens.

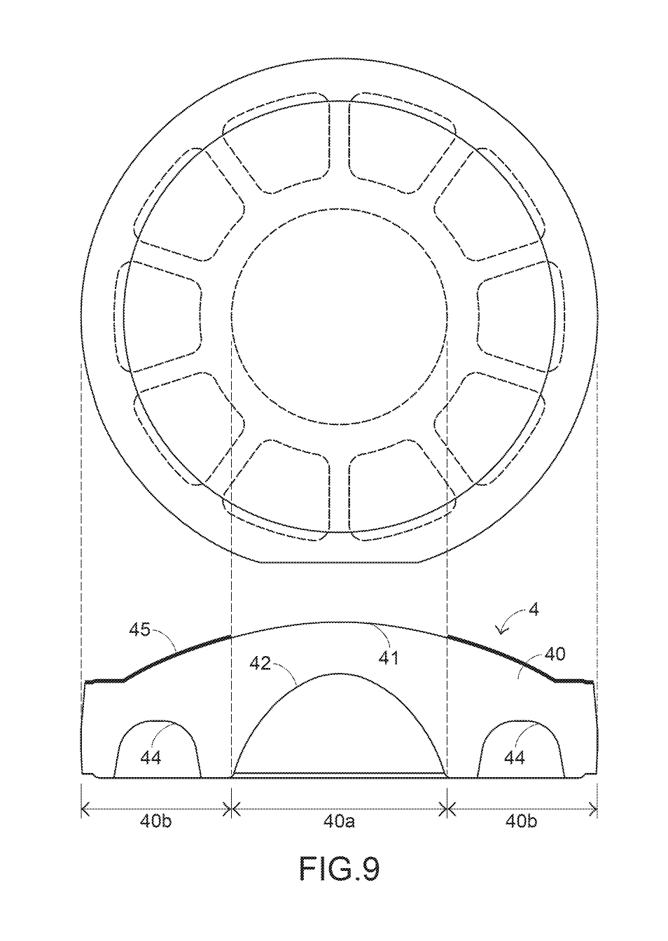

FIG. 8 is a schematic top view illustrating an optical lens formed from the injection mold of the present invention. FIG. 9 schematically illustrates the relationship between the top view and the cross-sectional view of the optical lens of the present invention. As shown in FIGS. 8 and 9, the optical lens 4 is produced by using the injection mold 2. The optical lens 4 comprises a lens body 40, a top curved surface 41 and a bottom curved surface 42. The top curved surface 41 and the bottom curved surface 42 are formed on the lens body 40. Moreover, the top curved surface 41 and the bottom curved surface 42 match the top inner surface 212 and the bottom inner surface 213 of the injection mold 2, respectively. Consequently, in this embodiment, both of the top curved surface 41 and the bottom curved surface 42 of the optical lens 4 are cambered upwardly in the same direction.

Moreover, the optical lens 4 further comprises an optically effective zone 40a and an optically ineffective zone 40b. Preferably, the optically effective zone 40a is located at a center region of the lens body 40. In case that the optical lens 4 is applied to a light source, plural light beams from the light source pass through the optically effective zone 40a. The optically ineffective zone 40b is located at a peripheral region of the lens body 40 and arranged around the optically effective zone 40a.

After the melt 9 is solidified and before the new-produced optical lens 4 is removed from the injection mold 2, the optically effective zone 40a of the optical lens 4 lies in the optically effective central runner 210a of the mold cavity chamber 210 and the optically ineffective zone 40b of the optical lens 4 lies in the optically ineffective annular runner 210b of the mold cavity chamber 210. That is, the optically effective zone 40a and the optically ineffective zone 40b of the optical lens 4 correspond to the optically effective central runner 210a and the optically ineffective annular runner 210b of the mold cavity chamber 210, respectively.

Hereinafter, the optically ineffective annular runner 210b will be illustrated in more details. Please refer to FIGS. 6 and 7 again. The optically ineffective annular runner 210b is arranged around the optically effective central runner 210a and in communication with the optically effective central runner 210a. Moreover, plural spoiler structures 214 are included in the optically ineffective annular runner 210b and protruded from the bottom inner surface 213 to the top inner surface 212. The arrangement of the plural spoiler structures 214 of the injection mold 2 can provide the functions of disturbing the flow of the melt 9 and decreasing the velocity of the melt 9 in the optically ineffective annular runner 210b while the melt 9 is injected into the mold cavity chamber 210. Since no spoiler structures are included in the optically effective central runner 210a, the flow of the melt 9 is not disturbed and the velocity of the melt 9 is not decreased. In other words, the melt 9 in the optically effective central runner 210a can continuously fill the mold cavity chamber 210. In an embodiment, the plural spoiler structures 214 include plural spoiler bulges, or the combination of plural spoiler bulges and plural spoiler recesses, or plural spoiler recesses. For facilitating illustration, plural spoiler bulges are the examples of the plural spoiler structures 214 in this embodiment. However, the examples of the plural spoiler structures 214 are not restricted.

FIG. 10 schematically illustrates the flowing condition of the melt within the mold cavity chamber during the process of forming the optical lens with the injection mold of the present invention. In this embodiment, the flow velocity of the melt 9 in the optically effective central runner 210a and the flow velocity of the melt 9 in the optically ineffective annular runner 210b are very close. Under this circumstance, before the optically ineffective annular runner 210b is completely filled with the melt 9, the optically effective central runner 210a is completely filled with the melt 9.

By means of the above injection mold, the optically effective central runner 210a is completely filled with the melt 9 before the optically ineffective annular runner 210b is completely filled with the melt 9. Consequently, the pore or melt line 29 is not formed in the optically effective central runner 210a. That is, after the melt 9 is solidified and the optical lens 4 is formed, plural mating structures 44 corresponding to the spoiler structures 214 of the injection mold 2 are formed in the optically ineffective zone 40b of the optical lens 4. The plural mating structures 44 are discretely formed in the optically ineffective zone 40b and arranged around the optically effective zone 40a in a circular permutation. Moreover, the pore or melt line 29 is not formed in the optically ineffective zone 40b. Since the defect (i.e., the pore or melt line 29) is formed in the optically ineffective zone 40b of the optical lens 4, the optical performance of the optical lens 4 is not adversely affected by the defect. According to the concept of designing the general optical lens, it is preferred that light beams are not transmissible through the optically ineffective zone 40b. Consequently, the possibility of causing reflection or diffusion of the light beams during the imaging process will be reduced. By means of the above design of the injection mold of the present invention, the pore or melt line or the improper bi-refraction or multi-refraction block will not be formed in the optically effective zone 40a of the optical lens 4. In other words, the optical performance of the optical lens 4 is largely improved.

Moreover, the arrangement of the plural mating structures 44 in the optically ineffective zone 40b of the optical lens 4 can provide the wave-guiding function. When the optical lens 4 and other lenses are combined together as a lens group, the light beams that are diffused to the optical lens 4 are gradually guided to the inner portions of the mating structures 44 and not discharged to the surroundings. Moreover, since the contour of the mating structures 44 of the optical lens 4 matches the contour of the injection mold 2, the mating structures 44 also include the corresponding mating bulges and/or the corresponding mating recesses. As mentioned above, the spoiler structures 214 of the injection mold 2 are plural spoiler bulges. Consequently, the mating structures 44 are the corresponding mating recesses.

Preferably, a sprayed coating 45 is formed on the top surface of the optical lens 4 corresponding to optically ineffective zone 40b. The sprayed coating 45 has a wave-breaking function so as to reduce the reflection or diffusion of light.

Moreover, after the melt 9 is solidified, it is necessary to open the disk-type mold base 21 and push out the solidified optical lens 4. Please refer to FIGS. 5 and 6. In a preferred embodiment, the disk-type mold base 21 comprises an upper-half mold base 21a and a lower-half mold base 21b. The upper-half mold base 21a and the lower-half mold base 21b are combined together to define the mold cavity chamber 210. After the optical lens 4 is solidified, the upper-half mold base 21a and the lower-half mold base 21b are separated from each other. Consequently, the final optical lens 4 is acquired. Moreover, for complying with the circular shape of the general optical lens, the disk-type mold base 21 is a circular disk-type mold base.

Moreover, for achieving the optimized efficiency, the plural spoiler structures 214 are included in the optically ineffective annular runner 210b in a circular permutation, and the plural spoiler structures 214 are arranged around the optically effective central runner 210a. Since the flow of the melt 9 in the optically ineffective annular runner 210b becomes turbulent, the velocity of the melt 9 is decreased. In some embodiments, at least one of the plural spoiler structures 214 is included in the optically ineffective annular runner 210b, and located near the gate 211. In other words, at least one of the plural mating structures 44 of the optical lens 4 is located near a gate land 43 of the optical lens 4.

In some other embodiments, two of the plural spoiler structures 214 are included in the optically ineffective annular runner 210b, and located near the gate 211. More especially, two of the plural spoiler structures 214 are symmetrically located at bilateral sides with respect to an injection direction of the gate 211. When the melt 9 flows to the bilateral sides of the optically ineffective annular runner 210b, the flow of the melt 9 is obstructed and the velocity of the melt 9 is decreased. Consequently, two of the mating structures 44 of the produced optical lens 4 are located near the land gate 43. That is, the mating structures 44 are symmetrically located at bilateral sides with respect to a normal line L of the gate land 43 of the optical lens 4.

From the above descriptions, the present invention provides an injection mold for an optical lens. The injection mold comprises plural spoiler structures. Consequently, the velocity of the melt in the optically ineffective annular runner is decreased. Under this circumstance, before the optically ineffective annular runner is completely filled with the melt, the optically effective central runner is completely filled with the melt. Since the defect (i.e., the pore, or melt line or improper residual stress) is not formed in the optically effective zone of the optical lens, the yield of the optical lens is enhanced. Moreover, the pore or melt formed in the optically ineffective zone of the optical lens will not adversely affect the optical performance of the optical lens. Moreover, the cyclically-arranged mating structures corresponding to the spoiler structures can strengthen the stress of the optical lens. Consequently, while the optical lens and other lenses are assembled as a lens group, the lens group is able to withstand a stronger force and has larger allowable tolerance.

While the invention is described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An injection mold for receiving a melt and producing an optical lens, the injection mold comprising:
a disk-type mold base, wherein a mold cavity chamber and a gate are defined by the disk-type mold base, and the gate is in communication with the mold cavity chamber, wherein the mold cavity chamber comprises:
an optically effective central runner arranged between a top curved surface and a bottom curved surface within the disk-type mold base, so that an outer contour of the optical lens matches the top curved surface and the bottom curved surface; and
an optically ineffective annular runner arranged around the optically effective central runner, wherein the optically ineffective annular runner is in communication with the optically effective central runner and the gate, wherein the disk-type mold base comprises plural spoiler structures in the optically ineffective annular runner,
at least one nozzle connected with the disk-type mold base, wherein the melt is injected from the at least one nozzle into the mold cavity chamber through the gate,
wherein the plural spoiler structures disturb flow of the melt, so that the optically effective central runner is completely filled with the melt before the optically ineffective annular runner is completely filled with the melt.

2. The injection mold according to claim 1, wherein the disk-type mold base is a circular disk-type mold base, and the plural spoiler structures include plural spoiler bulges and/or plural spoiler recesses.

3. The injection mold according to claim 1, wherein the disk-type mold base comprises an upper-half mold base and a lower-half mold base, wherein the upper-half mold base and the lower-half mold base are combined together to collaboratively define the mold cavity chamber.

4. The injection mold according to claim 1, wherein the plural spoiler structures are included in the optically ineffective annular runner in a circular permutation, and the plural spoiler structures are arranged around the optically effective central runner.

5. The injection mold according to claim 1, wherein at least one of the plural spoiler structures is included in the optically ineffective annular runner, and located near the gate.

6. The injection mold according to claim 1, wherein two of the plural spoiler structures are included in the optically ineffective annular runner, and symmetrically located at bilateral sides with respect to an injection direction of the gate.

7. The injection mold according to claim 1, wherein a curvature center of the top curved surface and a curvature center of the bottom curved surface are located at the same side with respect to the disk-type mold base.

8. The injection mold according to claim 1, wherein the top curved surface and the bottom curved surface are cambered upwardly, and the plural spoiler structures are protruded upwardly toward the top curved surface.

9. The injection mold according to claim 1, wherein the at least one nozzle includes plural nozzles, and the plural nozzles are in communication with the disk-type mold base.

10. An optical lens produced from an injection mold by an injection molding process, the optical lens comprising:
a lens body;
an optically effective zone located at a central region of the lens body, wherein plural light beams are allowed to pass through the optically effective zone;
an optically ineffective zone located at a peripheral region of the lens body, and arranged around the optically effective zone; and
plural mating structures corresponding to plural spoiler structures of the injection mold, wherein the plural mating structures are included in the optically ineffective zone and arranged around the optically effective zone.

11. The optical lens according to claim 10, wherein the lens body comprises a gate land, wherein at least one of the plural mating structures is located near the gate land.

12. The optical lens according to claim 10, wherein the lens body comprises a gate land, wherein two of the plural mating structures are located near the gate land, and symmetrically located at bilateral sides with respect to a normal line of the gate land.

13. The optical lens according to claim 10, wherein the lens body comprises a top curved surface and a bottom curved surface, wherein the top curved surface and the bottom curved surface are cambered upwardly in the same direction.

14. The optical lens according to claim 13, wherein inner surfaces of the plural mating structures, the top curved surface and the bottom curved surface are cambered upwardly in the same direction.

15. The optical lens according to claim 10, wherein a sprayed coating is formed on the optical lens corresponding to the optically ineffective zone, wherein the sprayed coating has a wave-breaking function so as to reduce reflection or diffusion of light.

16. The optical lens according to claim 10, wherein the plural mating structures include plural mating recesses and/or plural mating bulges.
